(19) United States
(12) Patent Application Publication
(10) Pub. No.: US 2007/0084343 A1
(43) Pub. Date: Apr. 19, 2007

(54) Solid/fluid contact treatment apparatus

(75) Inventor: Hiroyuki Hatano, Ibaraki (JP)

Correspondence Address: MORGAN LEWIS & BOCKIUS LLP, 1111 PENNSYLVANIA AVENUE NW, WASHINGTON, DC, 20004, US

(73) Assignee: National Institute of Advanced Industrial Science and Technology

(21) Appl. No.: 11/546,893

(22) Filed: Oct. 13, 2006

(30) Foreign Application Priority Data
Oct. 18, 2005 (JP) P. 2005-303207

(51) Int. Cl. B01D 53/14

(52) U.S. Cl. 95/150

(57) ABSTRACT

A plurality of fluid feed pipes having fluid percolation walls are arranged in a container, through which solid particles move downward, and the fluid passes through the pipes so that the contacts between the solid particles and the fluid are made with a low pressure loss. A plurality of solid particle feed pipes for forming spaces enclosed by fluid percolation walls are arranged in a container, through which the fluid flows, and the solid particles move through the solid particle feed pipes so that the contacts between the solid particles and the fluid are made with a low pressure loss. A plurality of bottom-opened fluid passages and having polygonal or semicircular sections are disposed in a container, through which solid particles move downward, and the fluid passes through the fluid passages so that the contacts between the solid particles and the fluid are made with a low pressure loss.

### BACKGROUND OF THE INVENTION

The invention relates to a solid/fluid contact treatment apparatus which enables solid particles, while being fed and discharged smoothly in a dehumidifying apparatus, an adsorbing apparatus, a heat exchanging apparatus or a chemical reaction apparatus, to contact with a fluid with a low pressure loss.

In the dehumidifying apparatus, adsorbing apparatus, the heat exchanging apparatus or the chemical reaction apparatus of the conventional art, the method of the fluidized bed, the moving bed, the fixed bed or the rotary kiln has been adopted to bring the solid particles and the fluid into contact so that the various gases or fluids including moisture contents may be exchanged between the solid particles and the fluids for the heat exchanges or for the chemical reactions such as catalytic actions.

When the aforementioned various treatments are to be performed by bringing the solid particles and the fluid into contact, the contact apparatus cannot be used if the pressure loss of the fluid to contact with the solid particles of a high flow rate becomes high, especially in the case of the contact treatment between the solid particles and the fluid.

In a desiccant air-conditioning apparatus, for example, the dehumidification is performed at a high airflow and in a low pressure loss while suppressing the pressure loss by holding the dehumidifier in the rotor having the honeycomb structure. However, the desiccant air-conditioning apparatus, in which the solid particles are held in the rotor having the honeycomb structure to cause the treated fluid to flow through the honeycomb fluid passage, has a limit in the particle holding quantity of the honeycomb surface, and has to perform the dehumidification and the reproduction at the same time. Therefore, the apparatus has its dehumidification capacity limited, and cannot be efficiently used unless the waste heat supply and the low temperature heat demand are identical. Thus, the use of the cold waste heat is difficult, and the size reduction is difficult.

Against this difficulty, the inventors et al. have proposed the fluidized bed type desiccant air-conditioning system, as shown in FIG. 9 and disclosed in JP-A-2005-30754. In this fluidized bed type desiccant air-conditioning system, there are separately disposed a reproducer 51 for drying porous particles having adsorbed moisture with heated air, and a treater 52 for dehumidifying the highly humid air in the room with the porous particles dried by the reproducer 51. In a reproduction tower 53 of the reproducer 51 and a treatment tower 63 of the treater 52, the air flow of a high speed is introduced into the porous particles from a porous particle container 57, so that a pneumatic transportation for transferring the porous particles in the air flow is formed to desorb the moisture content from the porous particles and to dehumidify the porous particles. The porous particles having their water content desorbed by the reproducer 51 are separated from the airflow and stored in a container 65, and are used in the treatment tower 63 to dehumidify the environmental air. Likewise, the porous particles having their water contents absorbed by the treater 52 are reserved in a container 55 so that they may be used in the reproduction tower 53.

By using this contact apparatus of the fluidized bed type for the solid particles and the fluid, the air treating range per unit volume can be drastically enlarged so that the contact area and the contact time between the air and the particles can be arbitrarily changed either by changing the fluid condition of the gas flow speed and the particle circulating rate within a range to form the pneumatic transportation or by changing the particle size. Moreover, the treatment is done by the pneumatic transportation so that the apparatus can treat with a small pressure loss.

[Patent Document 1]

JP-A-2005-30754

By adopting the aforementioned method, in which the solid particles and the fluid are made to contact with each other in the fluidized bed and in which the particles are made to circulate, as has been described by the inventors et al., more solid particles than those of the conventional method and the fluid can be made to contact, and the particles can be freely fed and extracted. Therefore, the contact method can follow to the load fluctuation easily, can enhance the using efficiency of the waste heat and can reduce the pressure loss of the fluid. Moreover, a chemical catalytic reactor, a photocatalytic reactor, a heat exchanger or the like, as described hereinbefore, is characterized in that it can enhance the solid/gas contact efficiency because the fluid passes through the clearances of the particle layers.

However, the entire apparatus is too large to apply the contacting method of the aforementioned fluidized bed type to the existing air-conditioning apparatus. At a high flow rate, moreover, the pressure loss at the sold/gas separation becomes so high as to cause a problem that the power cost is expensive. Thus, it has been desired to develop the contact method between the solid particles and the fluid with a less pressure loss. On the other hand, this method raises a problem that the reaction ratio is lowered or that the particles are worn by the complete mixing. The conventional method of using the fixed bed is troubled by a problem that the apparatus has to be interrupted for exchanging the particles. Therefore, the invention has an object to solve those problems of the conventional art.

### SUMMARY OF THE INVENTION

In order to solve the aforementioned problems, the present invention contemplates to realize the low pressure loss even in a large air flow rate, by an apparatus structure, in which a number of groups of fluid percolation pipes are arranged in a zigzag alignment in a rectangular pattern and in which the walls of the pipes are made of such a wire gauge or a porous material as to permeate the fluid. Moreover, the movements of the particles between the pipe groups can feed the particles in accordance with the load fluctuation. At this time, the pipes may allow the particles to flow within.

More specifically, the present invention adopts the following structure. In order to solve the aforementioned problems, there is provided a solid/fluid contact treatment apparatus including: a container through which solid particles move downward, and a plurality of fluid feed pipes having fluid percolation walls are arranged in the container, wherein the fluid passes through the pipes so that the contacts between the solid particles and the fluid are made with a low pressure loss.

Further, according to the invention, there is provided a solid/fluid contact treatment apparatus, including: a container through which the fluid flows, and a plurality of solid particle feed pipes for forming spaces enclosed by fluid percolation walls are arranged in the container, wherein the solid particles move through the solid particle feed pipes so that the contacts between the solid particles and the fluid are made with a low pressure loss.

Further, according to the invention, there is provided the solid/fluid contact treatment apparatus, wherein the fluid percolation walls are made of porous plates.

Further, according to the invention, there is provided the solid/fluid contact treatment apparatus, wherein the fluid percolation walls are made of flexible members.

Further, according to the invention, there is provided the solid/fluid contact treatment apparatus, wherein the flexible members are made of any of net- or sheet-like material such as metal, paper, cloth or polymer.

Further, according to the invention, there is provided the solid/fluid contact treatment apparatus, wherein the pipe having the fluid percolation walls has a polygonal or circular section or their combined section.

Further, according to the invention, there is provided the solid/fluid contact treatment apparatus, wherein the main axes of the moving directions of the solid particles and the flow directions of the fluids are set to arbitrary angles from the horizontal direction to the vertical direction.

Further, according to the invention, there is provided a solid/fluid contact treatment apparatus including: a container through which solid particles move, and a plurality of bottom-opened fluid passages and having polygonal or semicircular sections are disposed in the container, wherein the fluid passes through the fluid passages so that the contacts between the solid particles and the fluid are made with a low pressure loss.

Further, according to the invention, there is provided the solid/fluid contact treatment apparatus, wherein the apparatus operates at a constant temperature either by eliminating the heat of solid particles, as containing the heat generated by the mutual contacts of the solid particles, in contact with a fluid, or by feeding the heat of the contact with the fluid when the solid particles absorb the heat.

Further, according to the invention, there is provided the solid/fluid contact treatment apparatus, further including: a reservoir for feeding particles to the container or the solid particle feed pipes, and a particle retreater for retreating the particles having contacted with the fluid in the container or the solid particle feed pipes to feed the retreated particles to the reservoir, wherein the flow rate of the solid particles can be changed according to the fluctuation in the needed quantity of the particles.

Further, according to the invention, there is provided the solid/fluid contact treatment apparatus is used for a desiccant air-conditioning apparatus, wherein hygroscopic particles are used as the solid particles.

Further, according to the invention, there is provided the solid/fluid contact treatment apparatus for a noxious gas treating apparatus, wherein noxious gas adsorptive porous particles are used as the solid particles.

Further, according to the invention, there is provided the solid/fluid contact treatment apparatus for a noxious gas treating apparatus, wherein porous particles carrying a noxious gas absorptive liquid are used as the solid particles.

Further, according to the invention, there is provided the solid/fluid contact treatment apparatus for a photocatalytic reactor, wherein a photocatalyst is supported on the solid particles.

Further, according to the invention, there is provided the solid/fluid contact treatment apparatus for a heat exchanger, wherein porous or non-porous particles are used as the solid particles to make direct heat exchange with the fluid.

Further, according to the invention, there is provided the solid/fluid contact treatment apparatus for a chemical reaction apparatus, wherein porous particles are used as the solid particles to support a chemical reaction catalyst.

According to the invention, the low pressure-loss can be realized even in a large flow rate by using solid particles, thereby to cope with the high sold/fluid contact efficiency and the load fluctuation. Moreover, the fluid side can be handled as a plug flow thereby to realize a solid/fluid contact treatment apparatus of a high efficiency. In the case of using the apparatus as a desiccant air-conditioning apparatus, for example, in the apparatus of the conventional type, the heat generation by the dehumidification lowers the dehumidification. By utilizing the circulation of particles, the generated heat can be quickly removed by the heat transfer between the particles themselves and the fluid and by the insertion of the cooling pipes, thereby to prevent the temperature rise.

### BRIEF DESCRIPTION OF THE DRAWINGS

FIG. 1 is a schematic diagram of an embodiment of the invention.

FIGS. 2A and 2B are sectional views showing various modes of a container of the embodiment, in which solid particles flow down.

FIG. 3 is a schematic diagram of another embodiment of the invention.

FIGS. 4A to 4D are diagrams showing other modes of a solid particle feed pipe in the embodiment.

FIG. 5 is a diagram showing an example of the operation experiment of an apparatus, to which the invention is applied.

FIGS. 6A to 6C are diagrams showing modes of a gas feed pipe or a solid particle feed pipe in the invention.

FIGS. 7A to 7E are schematic diagrams of still another embodiment of the invention.

FIG. 8 is a diagram showing a further mode of the invention.

FIG. 9 is an explanatory view of the conventional art proposed by the inventors et al.

### DETAILED DESCRIPTION OF THE PREFERRED EMBODIMENTS

The problems to make a small size, to lower the pressure loss even for a high flow rate, to reduce the cost for powers, and to prevent reduction of reaction factors and attrition of particles are solved such that a plurality of fluid feed pipes having fluid percolation walls are arranged in a container, through which solid particles move downward, and the fluid passes through the pipes so that the contacts between the solid particles and the fluid are made with a low pressure loss, such that a plurality of solid particle feed pipes for forming spaces enclosed by fluid percolation walls are arranged in a container, through which the fluid flows, and the solid particles move through the solid particle feed pipes so that the contacts between the solid particles and the fluid are made with a low pressure loss, and such that a plurality of bottom-opened fluid passages and having polygonal or semicircular sections are disposed in a container, through which solid particles move downward, and the fluid passes through the fluid passages so that the contacts between the solid particles and the fluid are made with a low pressure loss.

### Embodiment 1

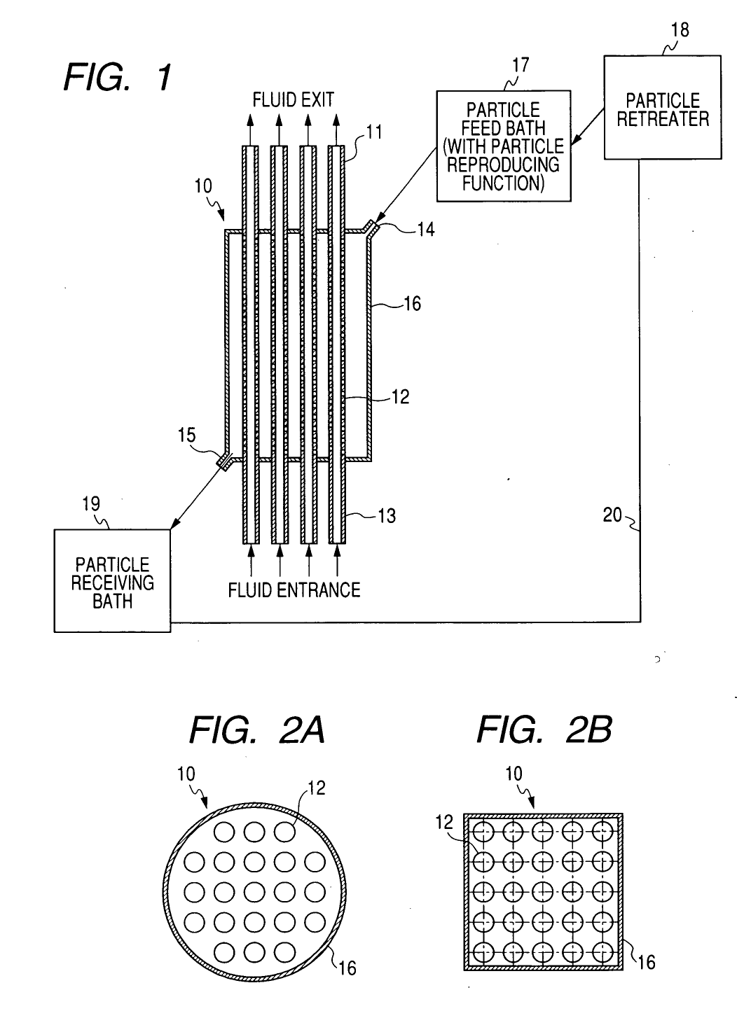

An embodiment for a fundamental aspect of the invention is shown in FIG. 1. A solid/fluid contact treatment apparatus 10, as shown in FIG. 1, is provided with a multiplicity of fluid feed pipes 12 extending in the vertical directions of the drawing through a container 16. This fluid feed pipes 12 form fluid percolation walls having such a number of holes in the portion positioned in the container 16 as are sized to permeate a fluid but not solid particles. In the shown embodiment, the fluid is fed to the porous fluid feed pipes 12 from lower fluid entrances 13 to upper fluid exits 11 so that the fluid feed pipes 12 are fluid riser pipes. On the other hand, the container 16 is fed with solid particles from a particle feed port 14 in the upper portion of the container to a particle discharge port 15 in the lower portion. Here, the fluid feed pipes 12 may be not only the fluid riser pipes, as described above, but also down-comer pipes for flowing the gas downward.

In case the apparatus shown in FIG. 1 is used as a treater in a desiccant air-conditioning apparatus using hygroscopic solid particles, the room air is fed to the fluid feed pipes 12, and the solid particles, as dried and reproduced by a particle retreater 18, are fed from a particle feed tank 17 through the particle feed port 14 to the inside of the container 16. The moisture in the fluid feed pipes 12 and in the room air having flown the porous walls into the container 16 is adsorbed by the dried hygroscopic solid particles, and the solid particles having adsorbed the moisture are discharged from the particle discharge port 15 in the lower portion of the container to a particle-receiving tank 19. The solid particles in the particle-receiving tank 19 are returned through a particle returning line 20 to the particle retreater 18, and are dried by the heated air so that the dried solid particles can be fed again to the container 16 acting as the treater.

When this solid/fluid contact treatment apparatus 10 is used as a reproducer in the desiccant air-conditioning apparatus, the fluid feed pipes 12 having the fluid permeating walls are fed with the dry air heated by the waste heat, and the particle feed port 14 is fed with the dried solid particles from the particle feed bath 17, so that the solid particles having adsorbed the moisture are dried by the dry air having flown into the fluid feed pipes 12 and the container and are reproduced to flow down from the particle discharge port 15 into the particle receiving tank 19. The reproduced solid particles in the particle-receiving tank 19 are returned from the particle returning line 20 to the particle retreater 18 thereby to adsorb the moisture in room air, and are fed again to the particle feed bath 17 so that they can be fed to the solid/fluid contact treatment apparatus 10 as the reproducer. As apparent from the example thus far described, the solid/fluid contact treatment apparatus 10 can be used for both the treater and the reproducer of the desiccant air-conditioning apparatus. Moreover, this desiccant air-conditioning apparatus can be used for both an open cycle and a closed cycle.

The apparatus, as shown in FIG. 1, can treat the gas, as fed in the aforementioned mode to the fluid feed pipes 12, and the solid particles, as fed to the inside of the container 16, so that it can be utilized not only as the aforementioned desiccant air-conditioning apparatus but also as the various apparatus. For example, when the gas containing various components is fed to the fluid feed pipes 12 and when the solid particles have adsorptivity to those components, the various components in the gas in the container 16 are adsorbed in the solid particles, and the solid particles are fed through the particle receiving tank 19 and the particle returning line 20 to the particle retreater 18 so that the solid particles are cleared of the various components and are fed back again from the particle feed tank 17 to the inside of the container 16. By providing the particle reserving bath and the reproducer, as described hereinbefore, the solid particle flow rate can be changed according to the fluctuations in the needed quantity of particles.

On the contrary, the solid particles may be reproduced, or the gas may be treated by feeding the inside of the container 16 with the solid particles having adsorbed the various components and by releasing the various components adsorbed by the solid particles, to the gas flowing in the fluid feed pipes 12. By this method, therefore, the apparatus can be used as the various solid-gas contact type chemical reaction apparatus or as a noxious gas adsorption treating apparatus of an adsorption particle circulation type. When a photocatalyst or a chemical reaction catalyst is to be supported on solid particles, the apparatus can also be used as an photocatalytic reactor or a chemical reactor for treating and purifying the air which contains the air pollutants flowing through the air feed pipes 12.

The heating gas, for example, is fed to the fluid feed pipes 12 in the apparatus of FIG. 1, and the solid particles are fed to the inside of the container 16 and are heated by the heating gas in the container 16. The solid particles thus heated can be utilized as various heat sources for heating purposes and, accordingly, as a heat exchanger. On the other hand, the gas, as cooled by the fluid feed pipes 12, is fed and heat-exchanged by the solid particles so that the cooled solid particles can be used as various cold heat sources. On the contrary, the apparatus can also be used as the various solid-gas direct contact type heat-exchanging apparatus by giving the hot heat or the cold heat from the solid particles to the gas flowing in the fluid feed pipes 12 by the aforementioned heat exchange, so that the heated or cooled gas is used for various applications. The solid particles need not be porous or adsorptive for those applications.

The material for the fluid-percolation gas feed pipes may be not only a rigid material such as a porous plate having no flexibility but also a flexible material such as a net-like or sheet-like metal, paper, cloth or polymer. On the other hand, the section of the container 16 can be formed into a circular shape, as shown in FIG. 2A, or various sections of polygons such as a square or hexagonal shape, as shown in FIG. 2B. Likewise, the fluid feed pipes 12 can adopt various sectional shapes such as a circular section or various polygons such as a square shape, as shown in FIGS. 2A and 2B. Moreover, the fluid feed pipes 12 can be disposed not only in vertical positions but also in horizontal positions or at an arbitrary angle in the container.

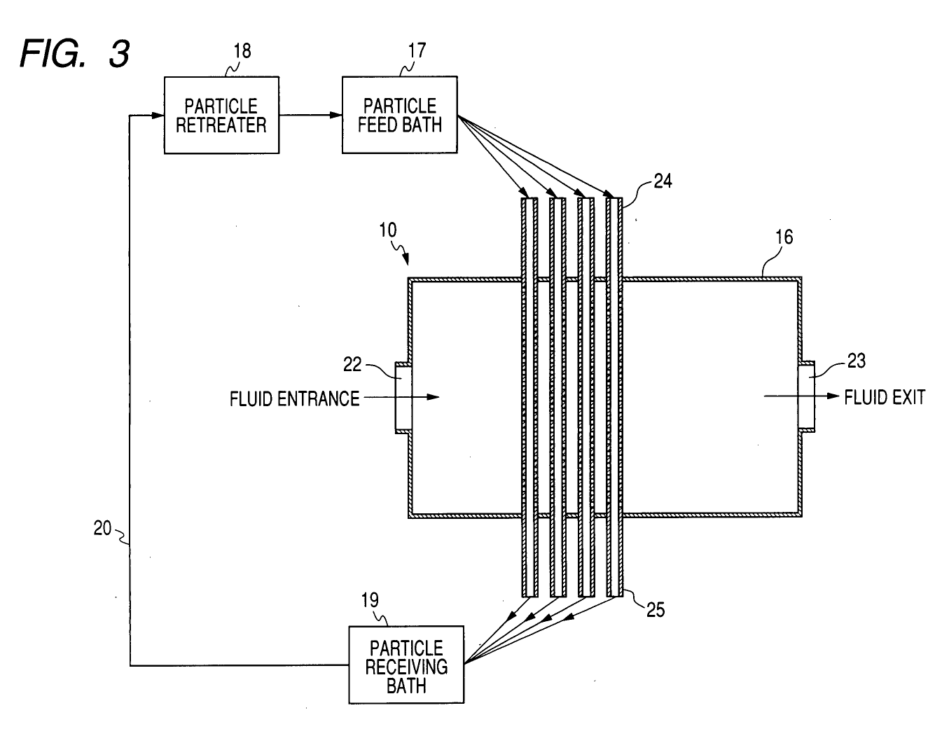

In the embodiment shown in FIG. 1, the fluid is fed to the fluid feed pipes 12 disposed in the container 16, and the solid particles are fed to the inside of the container. As shown in the solid/fluid contact treatment apparatus 10 of FIG. 3, for example, the container 16 is provided therein with a number of solid particle feed pipes 21 like the fluid feed pipes 12 of FIG. 1. The solid particles are fed, as in FIG. 1, from the particle feed bath 17 to the solid particle feed pipes 21 through a particle feed port 24, so that they flow down in the solid particle feed pipes 21 and are discharged from a particle discharge port 25 to the particle-receiving bath 19. The particles in the particle-receiving bath 19 are fed through the particle returning line 20 to the particle retreater 18. The particles are fed, after suitably treated in the particle retreater 18, like before from the particle feed bath 17 through the particle feed port 24 to the solid particle feed pipes 21 so that the particles are circulated and reused.

On the other hand, the fluid is fed from a fluid entrance 22 into the container 16 and is discharged from a fluid exit 23 so that the solid particles flowing down in the solid particle feed pipes 21 and the fluid flowing in the container 16 can contact with each other in the container 16. With this structure, too, treatments like those of the apparatus of FIG. 1 can be performed to treat the fluid efficiently with a low-pressure loss. The treater and the reproducer of the desiccant air-conditioning apparatus, the chemical reaction treatment including the catalytic treatment, and the heat exchange can be performed like those of the description of FIG. 1.

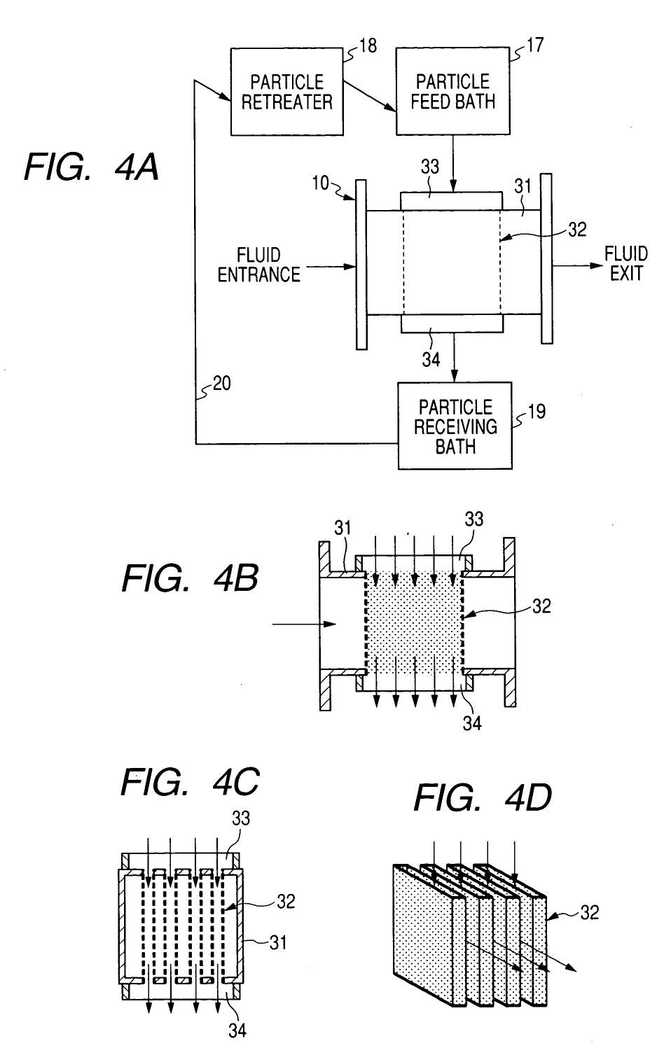

The foregoing embodiment shown in FIG. 1 presents an example, in which the porous pipes are extended through the container. In addition, the structure may be modified such that a number of particle feed members 32 are arranged with respect to fluid conduits 31, as shown to have a rectangular section in FIGS. 4A to 4D, so that the particles may flow from the top to the bottom of the particle feed members 32. This particle feed members 32 shown in FIG. 4 are made of a porous member having a rectangular section, as indicated in FIGS. 4B, 4C and 4D, and have their tops opened in particle feed portions 33 disposed outside of the walls of the fluid conduits 31 and their bottoms opened in particle discharge ports 34 disposed outside of the walls of the fluid conduits 31.

As in the foregoing embodiment, the particles from the particle feed bath 17 flow from the particle feed port 33 and down the porous particle feed members 32 and are collected from the particle discharge port 34 by the particle receiving bath 19. The particles are fed through the particle returning line 20 and are treated by the particle retreater 18. The particles are fed again from the particle feed bath 17 to the particle feed members 32 so that they are circulated and reused. As in the apparatus shown in FIG. 3, too, the apparatus thus far described can perform the efficient fluid treatment with a low pressure-loss. The treater and the reproducer of the desiccant air-conditioning apparatus, the chemical reaction treatment including the catalytic treatment, and the heat exchange can be performed like those of the description of FIG. 1.

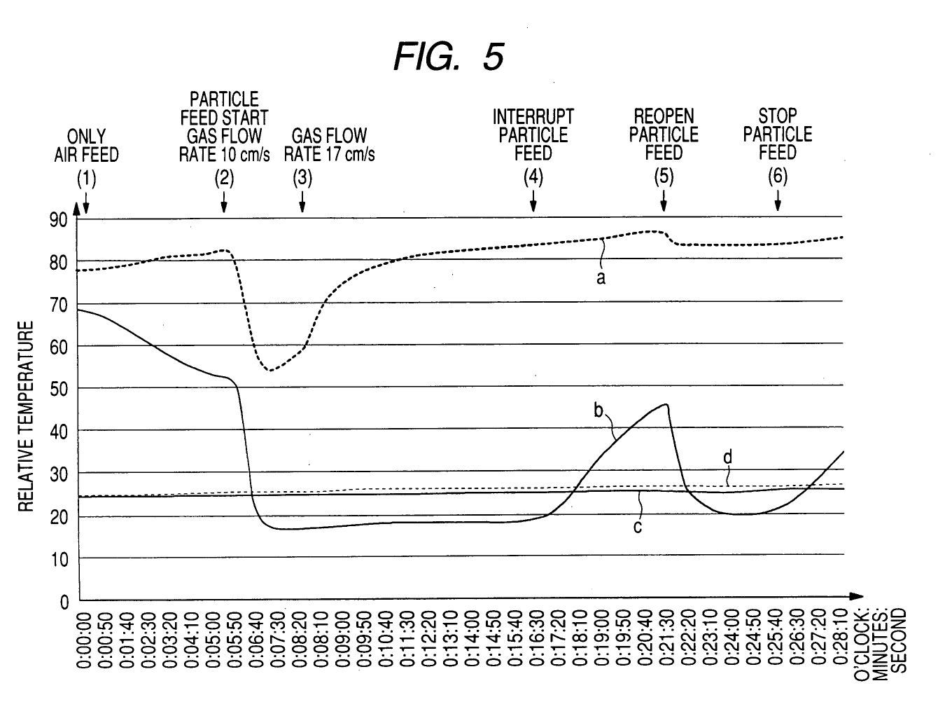

The results of the experiments, which are performed by using the aforementioned apparatus, are shown in FIG. 5. In the example of FIG. 5, the solid/fluid contact treatment apparatus shown in FIG. 1 uses the solid/gas contact apparatus having circular tubes of a diameter of 20 mm formed by using a wire gauge having an aperture of 150 microns. By using this solid/gas contact apparatus, the tubes are fed with air, and the container is fed with the moisture adsorbing particles. In FIG. 5, curve a is a graph plotting the entrance humidity change of the air flowing in the tubes; curve b is a graph plotting the exit humidity change of the same; curve c is a graph plotting the entrance temperature change of the same; and curve d is a graph plotting the exit temperature change of the same.

In this apparatus, as shown in FIG. 5, the measurements are started at the time (1) by feeding only the air but not the particles. Then, the exit humidity is gradually lowered by the influences of the particles accumulated in the lower portion of the apparatus. When the falling feed of the particles is started at (2), the humidity on the exit side abruptly drops. As shown, however, the humidity on the entrance side also drops. The gas flow speed at this time is 10 cm/s. When the gas flow speed is increased at (3) to 17 cm/s, the entrance humidity becomes substantially constant, and the exit humidity also becomes constant at about 18%. The pressure loss at this time is substantially 0. When the particle feed is once stopped at (4), the exit humidity gradually increases. When the feed of the particles is restarted at (5), the exit humidity abruptly decreases again. When the particle feed is stopped again at (6), the exit humidity gradually increases. It has been apparently confirmed from these experimental results that the desired actions can be attained by the solid/fluid contact treatment apparatus according to the invention.

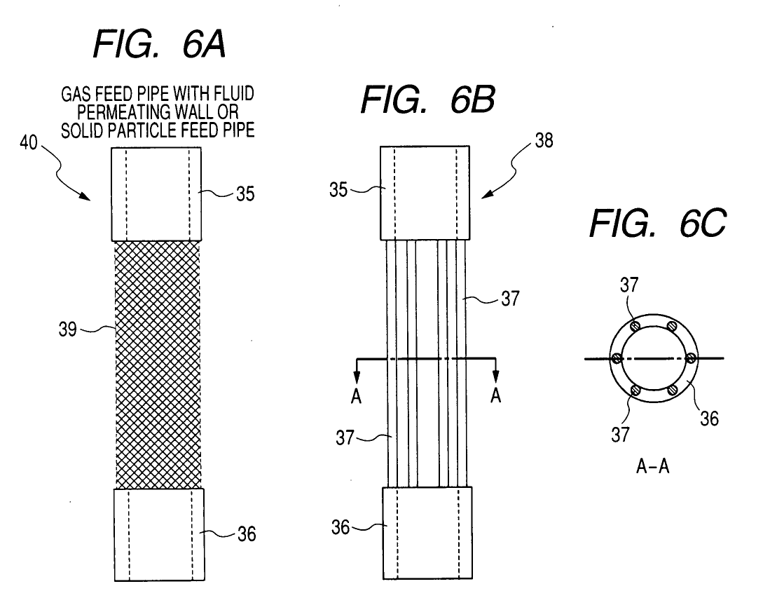

FIGS. 6A to 6C show the aspects of the fluid feed pipe or the solid feed pipe shown in FIGS. 1 to 4. As shown in FIG. 6B, a first cylinder 35 and a second cylinder 36 of a cylindrical shape having passages therein are connected through six supporting rods 37, as shown in FIGS. 6B and 6C, to form a pipe structuring member 38. This pipe structuring member 38 is wound on its supporting rods by a fluid percolator 39, which is made of a flexible porous member such as a wire gauge, as shown in FIG. 6A, thereby to structure a flowing pipe 40 functioning as a gas flowing pipe or a solid flowing pipe.

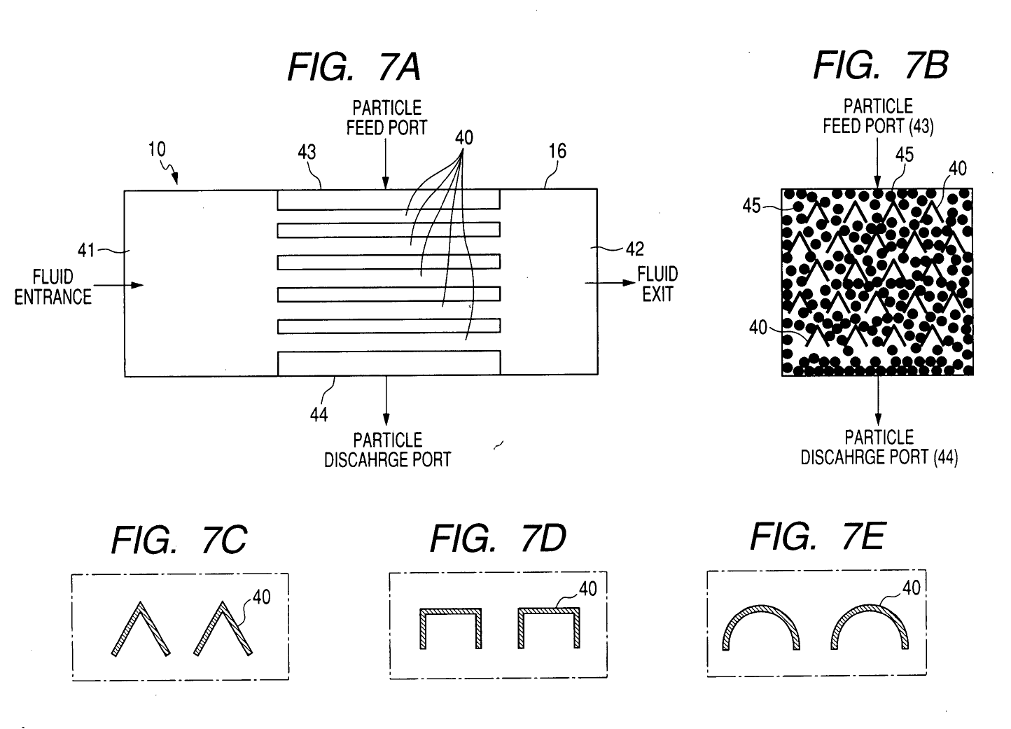

The solid/fluid contact treatment apparatus can be practiced in more various aspects, such that it may have a bottom-opened gas passage, as shown in FIG. 7. In the examples shown in FIGS. 7A to 7C, the fluid passage 40 having a bottom-opened triangular section in the container 16 of the solid/fluid contact treatment apparatus 10, as shown in FIG. 7C, is arranged in multiplicity horizontally, as shown in FIGS. 7A and 7B. In this state, a fluid such as air is fed into the container 16 from a fluid entrance 41 to a fluid exit 42, and particles 45 are made to flow down from particle feed port 43 disposed above the container 16 into a particle discharge port 44 disposed below.

Thus, when the particles 45 flow down, they hardly enter the insides of the fluid passages 40 having a bottom-opened triangular section, and these portions provide gas passages having little flow resistance. The contacts between the gas to flow mainly through the fluid passages 40 and the particles flowing down therearound can attain functions similar to those of the solid/fluid contact treatment apparatus. When the fluid speed from the fluid entrance 41 is sufficiently higher than the weight of the downward particles, the particles may be scattered by the fluid. It is, therefore, preferred to provide a porous member such as the particle impermeable wire gauge all over the downstream portion of the fluid passage 40. Moreover, the shape of the fluid passage 40 is not limited to the bottom-opened triangular section, as shown in FIG. 7C, but may be various modes or polygons such as a bottom-opened rectangular section, as shown in FIG. 7D, or an arcuate section opened downward, as shown in FIG. 7E. In the apparatus thus described, too, the various treatments can be done as in that described with reference to FIG. 1 and so on.

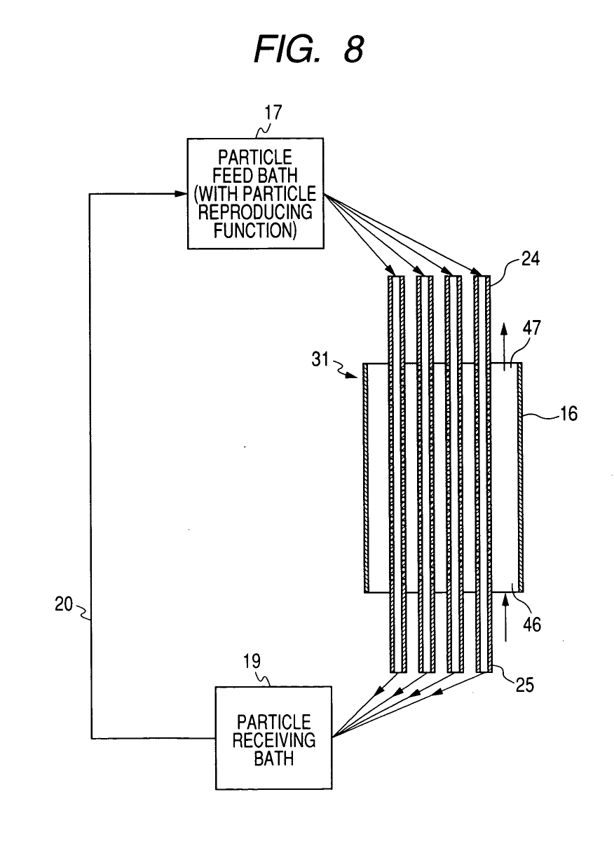

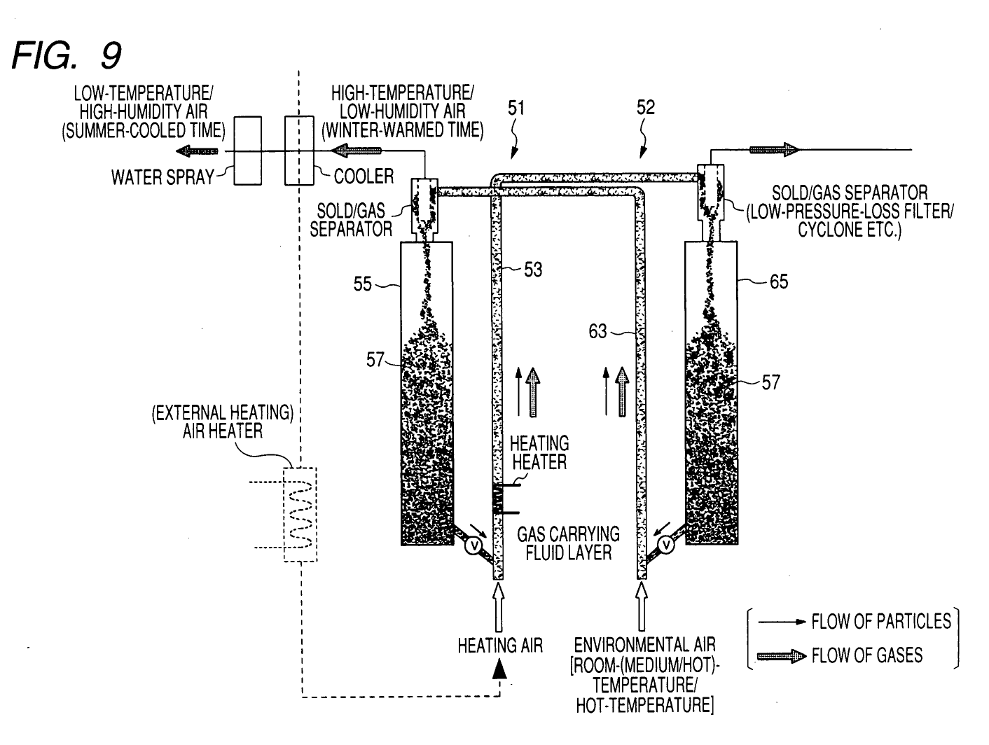

In the foregoing embodiment shown in FIG. 3, on the other hand, the fluid is fed horizontally of the drawing from the fluid entrance 22 to the fluid exit 23. In addition, the invention can also be practiced for the operations similar to those of the aforementioned individual embodiments, as shown in FIG. 8, such that the container 16 is formed into a vertically extending tubular shape, and such that the fluid is fed from a downward open fluid entrance 46 to an upward open fluid exit 47. Thus, in the invention, the main axes of the moving directions of the solid particles and the flow directions of the fluids can be set to arbitrary angles from the horizontal direction to the vertical direction.

The fluid/solid contact apparatus having the aforementioned actions can be effectively used not only in the open cycle and closed cycle desiccant air-conditioning apparatus of the dehumidifying particle circulation type but also for wide applications such as the noxious gas adsorption treating apparatus of the adsorption particle circulation type, the noxious substance treating apparatus carrying photocatalysts for treating the air-polluting substances, the solid/gas direct heat exchanger or the solid/gas contact reactor.

What is claimed is:

1. A solid/fluid contact treatment apparatus comprising:
a container through which solid particles move downward, and
a plurality of fluid feed pipes having fluid percolation walls are arranged in the container, wherein
the fluid passes through the pipes so that the contacts between the solid particles and the fluid are made with a low pressure loss.

2. A solid/fluid contact treatment apparatus, comprising:
a container through which the fluid flows, and
a plurality of solid particle feed pipes for forming spaces enclosed by fluid percolation walls are arranged in the container, wherein
the solid particles move through the solid particle feed pipes so that the contacts between the solid particles and the fluid are made with a low pressure loss.

3. The solid/fluid contact treatment apparatus as set forth in claim 1, wherein
the fluid percolation walls are made of porous plates.

4. The solid/fluid contact treatment apparatus as set forth in claim 1, wherein
the fluid percolation walls are made of flexible members.

5. The solid/fluid contact treatment apparatus as set forth in claim 4, wherein
the flexible members are made of any of net- or sheet-like material such as metal, paper, cloth or polymer.

6. The solid/fluid contact treatment apparatus as set forth in claim 1, wherein
the pipe having the fluid percolation walls has a polygonal or circular section or their combined section.

7. The solid/fluid contact treatment apparatus as set forth in claim 1, wherein
the main axes of the moving directions of the solid particles and the flow directions of the fluids are set to arbitrary angles from the horizontal direction to the vertical direction.

8. A solid/fluid contact treatment apparatus, comprising:
a container through which solid particles move downward, and
a plurality of bottom-opened fluid passages and having polygonal or semicircular sections are disposed in the container, wherein
the fluid passes through the fluid passages so that the contacts between the solid particles and the fluid are made with a low pressure loss.

9. The solid/fluid contact treatment apparatus as set forth in claim 1, wherein
the apparatus operates at a constant temperature either by eliminating the heat of solid particles, as containing the heat generated by the mutual contacts of the solid particles, in contact with a fluid, or by feeding the heat of the contact with the fluid when the solid particles absorb the heat.

10. The solid/fluid contact treatment apparatus as set forth in claim 1, further comprising:
a reservoir for feeding particles to the container or the solid particle feed pipes, and
a particle retreater for retreating the particles having contacted with the fluid in the container or the solid particle feed pipes to feed the retreated particles to the reservoir, wherein
the flow rate of the solid particles can be changed according to the fluctuation in the needed quantity of the particles.

11. The solid/fluid contact treatment apparatus for a desiccant air-conditioning apparatus as set forth in claim 1, wherein
hygroscopic particles are used as the solid particles.

12. The solid/fluid contact treatment apparatus for a noxious gas treating apparatus as set forth in claim 1, wherein
noxious gas adsorptive porous particles are used as the solid particles.

13. The solid/fluid contact treatment apparatus for a noxious gas treating apparatus as set forth in claim 1, wherein
porous particles carrying a noxious gas adsorptive liquid are used as the solid particles.

14. The solid/fluid contact treatment apparatus for a photocatalyst reaction apparatus as set forth in claim 1, wherein
a photocatalyst is supported in the solid particles.

15. The solid/fluid contact treatment apparatus for a heat exchanger as set forth in claim 1, wherein
porous or non-porous particles are used as the solid particles to make direct heat exchange with the fluid,

16. The solid/fluid contact treatment apparatus for a chemical reaction apparatus as set forth in claim 1, wherein
porous particles are used as the solid particles to support a chemical reaction catalyst.

17. The solid/fluid contact treatment apparatus as set forth in claim 2, wherein
the fluid percolation walls are made of porous plates.

18. The solid/fluid contact treatment apparatus as set forth in claim 2, wherein
the fluid percolation walls are made of flexible members.

19. The solid/fluid contact treatment apparatus as set forth in claim 18, wherein
the flexible members are made of any of net- or sheet-shaped material such as metal, paper, cloth or high-molecular material.

20. The solid/fluid contact treatment apparatus as set forth in claim 2, wherein
the pipe having the fluid percolation walls has a polygonal or circular section or their combined section.

21. The solid/fluid contact treatment apparatus as set forth in claim 2, wherein
the main axes of the moving directions of the solid particles and the flow directions of the fluids are set to arbitrary angles from the horizontal direction to the vertical direction.

22. The solid/fluid contact treatment apparatus as set forth in claim 2, wherein
the apparatus operates at a constant temperature either by eliminating the heat of solid particles, as containing the heat generated by the mutual contacts of the solid particles, in contact with a fluid, or by feeding the heat of the contact with the fluid when the solid particles absorb the heat.

23. The solid/fluid contact treatment apparatus as set forth in claim 2, further comprising:
a reservoir for feeding particles to the container or the solid particle feed pipes, and
a particle retreater for retreating the particles having contacted with the fluid in the container or the solid particle feed pipes to feed the retreated particles to the reservoir, wherein
the flow rate of the solid particles can be changed according to the fluctuation in the needed quantity of the particles.

24. The solid/fluid contact treatment apparatus for a desiccant air-conditioning apparatus as set forth in claim 2, wherein
hygroscopic particles are used as the solid particles.

25. The solid/fluid contact treatment apparatus for a noxious gas treating apparatus as set forth in claim 2, wherein
noxious gas adsorptive porous particles are used as the solid particles.

26. The solid/fluid contact treatment apparatus for a noxious gas treating apparatus as set forth in claim 2, wherein
porous particles carrying a noxious gas adsorptive liquid are used as the solid particles.

27. The solid/fluid contact treatment apparatus for a photocatalyst reaction apparatus as set forth in claim 2, wherein
a photocatalyst is supported in the solid particles.

28. The solid/fluid contact treatment apparatus for a heat exchanger as set forth in claim 2, wherein
porous or non-porous particles are used as the solid particles to make direct heat exchange with the fluid.

29. The solid/fluid contact treatment apparatus for a chemical reaction apparatus as set forth in claim 2, wherein
porous particles are used as the solid particles to carry a chemical reaction catalyst.

30. The solid/fluid contact treatment apparatus as set forth in claim 8, wherein
the apparatus operates at a constant temperature either by eliminating the heat of solid particles, as containing the heat generated by the mutual contacts of the solid particles, in contact with a fluid, or by feeding the heat of the contact with the fluid when the solid particles absorb the heat.

31. The solid/fluid contact treatment apparatus as set forth in claim 8, further comprising:
a reservoir for feeding particles to the container or the solid particle feed pipes, and
a particle retreater for retreating the particles having contacted with the fluid in the container or the solid particle feed pipes to feed the retreated particles to the reservoir, wherein
the flow rate of the solid particles can be changed according to the fluctuation in the needed quantity of the particles.

32. The solid/fluid contact treatment apparatus for a desiccant air-conditioning apparatus as set forth in claim 8, wherein
hygroscopic particles are used as the solid particles.

33. The solid/fluid contact treatment apparatus for a noxious gas treating apparatus as set forth in claim 8, wherein
noxious gas adsorptive porous particles are used as the solid particles.

34. The solid/fluid contact treatment apparatus for a noxious gas treating apparatus as set forth in claim 8, wherein
porous particles carrying a noxious gas absorptive liquid are used as the solid particles.

35. The solid/fluid contact treatment apparatus for a photocatalyst reaction apparatus as set forth in claim 8, wherein
a photocatalyst is carried in the solid particles.

36. The solid/fluid contact treatment apparatus for a heat exchanger as set forth in claim 8, wherein
porous or non-porous particles are used as the solid particles to make direct heat exchange with the fluid.

37. The solid/fluid contact treatment apparatus for a chemical reaction apparatus as set forth in claim 8, wherein
porous particles are used as the solid particles to carry a chemical reaction catalyst.
